(19) United States
(12) Patent Application Publication
(10) Pub. No.: US 2010/0280944 A1
(43) Pub. Date: Nov. 4, 2010

(54) PAPERLESS CHECKING TRANSACTIONS

(75) Inventors: Gak Wee Low, Sunnyvale, CA (US); Lu Hua, Fermont, CA (US); Tejas Arvindbhai Kotecha, Milpitas, CA (US); Nitin Kulshrestha, Menlo Park, CA (US)

Correspondence Address: HAYNES AND BOONE, LLP;IP Section, 2323 Victory Avenue, Suite 700, Dallas, TX, 75219, US

(73) Assignee: eBay Inc., San Jose, CA (US)

(21) Appl. No.: 12/433,800

(22) Filed: Apr. 30, 2009

(51) Int. Cl. G06Q 40/00

(52) U.S. Cl. 705/40

(57) ABSTRACT

According to one embodiment, a user logs into a bank account and access a bill payment service through the bank. The user enters a recipient's email address and an amount to be transferred from the user's account to the recipient. The bill payment service transfers the amount to a payment provider, who then transfers the amount to the recipient if the recipient has an account with the payment provider. As a result, recipients who are not part of a bill payment service can quickly receive payments, and users can make quickly and easily payments to recipients who are not part of a bill payment service by simply entering an email address and payment amount.

### BACKGROUND

1. Technical Field

The present invention generally relates to on-line transactions and, more particularly, to facilitating fund transfers over a network.

2. Related Art

Before the proliferation of electronic on-line financial transactions, payments between parties, such as person to person, person to company, company to person, or company to company, were made primarily through paper checks. A payer would typically fill out a check with the recipient's name and the amount of payment and sign and date the check. The check would then be mailed or otherwise delivered to the recipient, who would then deposit the check into an account or cash the check, which typically would require the recipient to physically go to a bank or check cashing center. Such a process has numerous disadvantages, including inconvenience to both the payer and recipient, costs of postage and checks, lost checks in the mail, and delays in actual payment due to the time required to send, receive, and cash or deposit the check.

Financial service providers have addressed this problem by allowing users to electronically make payments over networks, such as the Internet. One example is Bill Pay, which is offered by financial institutions, such as banks and credit unions. Bill Pay allows a user to pay bills electronically through the user's bank account. The user signs up for the service through their financial institution and enters information about the recipient. For example, if the recipient is a mortgage company or utility company with regular payments due, the user enters the requested information (e.g., name, address, and account information) and can set up recurring payments each month or any periodic interval. On the requested date, the request transfer amount is debited from the user's account and transferred electronically to the recipient's account.

However, Bill Pay also has disadvantages. One, the user is required to enter account information of the recipient, which may not be readily available. For example, typically, the user needs to have the bill in front of him when entering the information. Two, many companies or potential recipients are not part of the Bill Pay network. As a result, Bill Pay may only have limited uses to a user, especially with the ever-increasing use of on-line purchases and money transfers between individuals and small businesses.

As such, there currently exists a need to expand a user's ability to make payments online to more recipients and provide an easier to user system for making payments on-line.

### SUMMARY

According to one embodiment of the present disclosure, systems and methods presented herein facilitate transactions over a network to enable users to pay virtually any recipient by simply entering in the recipient's email or other identifier. In one embodiment, a user or payer with a bank account signs up with Bill Pay or a similar service that allows a user to make a payment to a recipient through the user's bank or financial institution account. The user enters information about the recipient, such as an e-mail address, and the amount to be paid. This information is transmitted the bill payment service network, such as iPay or MasterCard RPPS (Remote Payment and Presentment Service). If the recipient is member of the bill payment network, funds are electronically transferred to the recipient. However, if the recipient is not a member of the network (e.g., individuals or small merchants), the bill payment service communicates the recipient information (e.g., an email address) to PayPal or a similar on-line payment provider. If the recipient's information matches to an account with the payment provider, the indicated amount is transferred to the recipient's account with the payment provider through the bill payment network. If the recipient does not have an account with the payment provider, the payment provider may send the recipient a message to the email address, asking the recipient if the recipient would like to sign up for a payment provider account and receive funds from the payer. As a result, funds can be quickly and easily transferred from a payer to a recipient, with the only requirement that the recipient have an account with the payment provider.

Thus, the payment provider acts as a “middle man” between the bill payment network/payer and the recipient, such that the payer simply needs to type in the name of the recipient, just like with a check, and the amount to be paid to the recipient through the user's on-line bank account. Information from the payment provider is used to transfer the money from the payer's bank account to the recipient's payment provider account through the bill payment network. The payer does not have to have a payment provider, and can affect the transfer by simply entering the recipient's name, as opposed to a bank account and routing number or other hard-to-remember information. The payment provider verifies the recipient through its database. Current users with payment provider accounts can be given an easy opt-in option when a fund transfer is attempted. If the information entered by the payer includes an email address, the payment provider can invite the recipient to open an account to receive the funds. Security, fraud, and risk issues can be handled through the payment provider's standard models or modified accordingly. As a result, money can be transferred quickly, easily, and without paper to recipients, even when the payer does not have an account with the payment provider. Recipients can be individuals, small merchants, or anyone not part of a bill pay network.

These and other features and advantages of the present disclosure will be more readily apparent from the detailed description of the embodiments set forth below taken in conjunction with the accompanying drawings.

### BRIEF DESCRIPTION OF THE DRAWINGS

FIG. 1 is a block diagram of a system adapted to facilitate fund transfers over a network, in accordance with an embodiment of the present disclosure;

FIG. 2 is a flowchart showing a method for facilitating fund transfers over a network, in accordance with an embodiment of the present disclosure;

FIG. 3 is a flowchart showing a financial institution-side method for making a payment over a network, in accordance with an embodiment of the present disclosure;

FIG. 4 is a flowchart showing a payment provider-side method for making a payment over a network, in accordance with an embodiment of the present disclosure; and

FIG. 5 is a block diagram of a computer system suitable for implementing one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

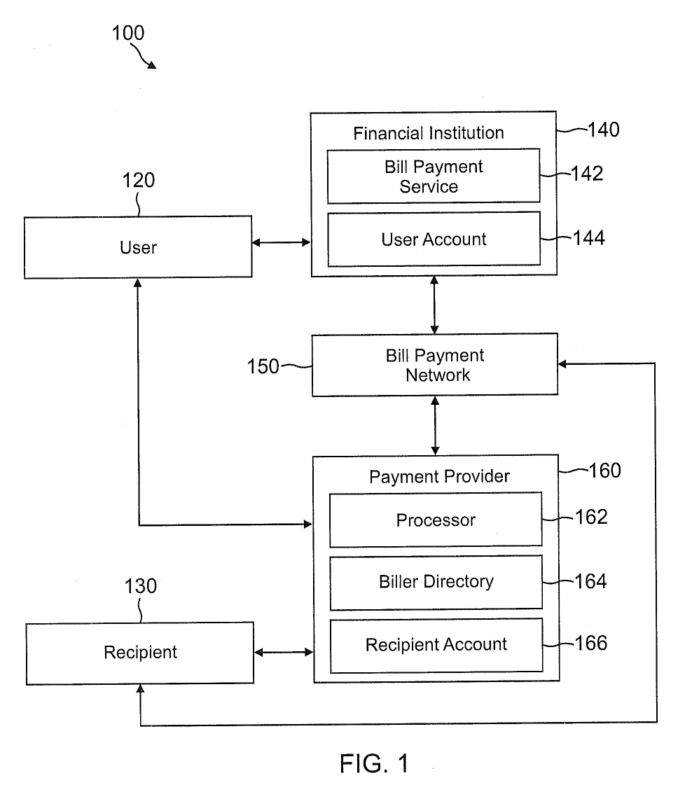

FIG. 1 shows one embodiment of a system 100 for facilitating financial transactions including fund transfers over a network, such as the Internet, using a bill payment network even if the recipient is not part of the bill payment network. System 100 includes a user 120 (e.g., a payer or customer) adapted to interface with a financial institution 140 (e.g., a bank or credit union), a bill payment network 150 (e.g., Bill Pay), and an on-line payment provider 160 (e.g., PayPal, Inc. of San Jose, Calif.) over a network.

User 120, in one embodiment, is able to establish a user account 144 with financial institution 140, such as a bank, such that user 120 may deposit and withdraw monetary funds in and from user account 144. Financial institution 140 is adapted to provide user 120 with access to user account 144 and to a bill payment service 142 via bill payment network 150 from the financial institution web site. In one aspect, the user 120 may request network based transactions, such as payments from user account 144 to recipients that are part of bill payment network 150.

Conventionally, user 120 may utilize bill payment service 142 to transfer funds from user account 144 of the financial institution to a recipient who is a part of bill payment network 150, such as credit card issuers, utility companies, mobile network operators, large retailers, etc., through bill payment network 150. This service is currently available to allow individuals to pay bills from their bank account to recipients who are part of Bill Pay or other similar networks directly from bill payment network 150 to a recipient 130. Recipient 130 may be an individual, a small or mid-sized merchant, or virtually any person or entity desirous of receiving funds electronically. In one embodiment, user 120 may also utilize bill payment service 142 to transfer funds from user account 144 to recipients who are not part of bill payment network 150. In this case, payment provider 160 is part of bill payment network 150.

In one embodiment, payment provider 160 keeps and maintains a master directory of users (receivers). This directory contains information about its users, including names, mailing addresses, e-mail addresses, etc., and is connected and shared with bill payment network 150. The information from the payment provider master directory supplements the existing information available in bill payment network 150. Payment provider 160 maintains and updates this master directory as users are added or removed from the directory system, as well as any information changes to existing users, such as change of mailing address or email address. In one embodiment, payment provider 160 uses any infrastructure and programs, such as fraud detection and prevention algorithms, to ensure the integrity and security of user information. Bill payment network 150 may first search for recipients/payees in their existing directory, which contains “traditional” or conventional recipients, such as mobile network operators, large retailers, etc. If the intended recipient/payee is not found, bill payment network 150 may then search for the designated recipient/payee in the master directory of payment provider 160. If the recipient/payee is found in the master directory, the recipient/payee information, such as name, e-mail address, etc., can be displayed as a valid payee. If the recipient/payee is not found, payment provider 160 may send a request to the recipient/payee to sign up for an account. Additional details are provided below.

User 120, in one embodiment, accesses user account 144 through the financial institution website. If user 120 has not signed up for bill payment service 142, the user signs up through the website by providing requested information, which may differ from service to service. Bill payment service 142 can be any suitable service that enables a user to make payments through the user's bank account, examples include Bill Pay, Paytrust, and CheckFree. The user enters information about the recipient. In one embodiment, the user enters the recipient's email address. Other information may include the recipient's name, phone number, address, or a combination thereof. User 120 also enters the amount to be transferred from user account 144 to recipient 130.

Information entered by user 120 is processed by bill payment network, such as by MasterCard's RPPS, Metavante, CheckFree, Online Resources (ORCC), and iPay, to affect a transfer of the requested funds from user account 144 to payment provider 160 acting as a biller with the bill payment service. In one embodiment, a clearing house (not shown) resolves financial transactions through validation, delivery, and settlement to debit user account 144 in accordance with an amount specific to the fund transfer and credit payment provider 160 the network. Payment provider 160, through a processing component 162, determines whether the recipient has an account with the payment provider, such as searching through a recipient or biller directory 164 for the recipient's email address. Biller directory can be stored in a readable and writable memory. If the intended recipient does not have an account, payment provider 160 may contact recipient 130 through information provided by user 120, such as an email address, phone number, or mailing address. The payment provider may inform recipient 130, such as through an email, text message, recorded voice message, or letter, that user 120 has authorized deposit of funds to recipient 130 and request the recipient to open an account with the payment provider if the user desires to have the funds received in this manner.

If the recipient has an account with payment provider 160, either newly opened or pre-existing, the requested funds are transferred to a recipient account 166 associated with intended recipient 130. Processing component 162 may be adapted to process the fund transfer to recipient account 166. In some embodiments, payment provider 160 may implement security and/or risk processes to ensure the transfer from user 120 to recipient 130 is proper and authentic before making the transfer. Because user 120 is first required to log into user account 144 at financial institution 140, a level of security and trust is provided through financial institution 140. If user 120 also has an account with payment provider 160, payment provider 160 has the ability to provide additional security measures that are part of the payment provider system. Once payment provider has completed the transfer, recipient 130 and/or user 120 may be notified, either directly or indirectly, that the requested finds have been transferred to the desired recipient. Recipient 130 may then withdraw finds or transfer funds to another account maintained by a different system, such as a bank.

In one embodiment, one or more monetary transfers between user 120, recipient 130, financial institution 140, and payment provider 160 may take place over the network, such as a single network or a combination of multiple networks. For example, the network may include the Internet and/or one or more intranets, landline networks, wireless networks, and/or other appropriate types of communication networks. In another example, the network may include a wireless telecommunications network (e.g., cellular phone network) adapted to interface and communicate with other communication networks, such as the Internet. As such, in one aspect, user 120, recipient 130, financial institution 140, and payment provider 160 may be associated with a particular link (e.g., a link, such as a URL (Uniform Resource Locator) to an IP (Internet Protocol) address.

User 120, in one embodiment, may utilize a network interface device having a display, such as a personal computer (i.e., PC), a wireless telephone (e.g., cellular phone), a personal digital assistant (i.e., PDA), a notebook computer, and/or various other generally known types of wired and/or wireless computing devices (“user device”), to communicate and interface with financial institution 140 and/or payment provider 160 to access user account 144 and/or recipient account 166 via any appropriate combination of hardware and/or software configured for wired and/or wireless communication over the network. For instance, user 120 may utilize a network interface application (e.g., a network browser application) to communicate and interface with financial institution 140 and/or payment provider 160 to access user account 144 and recipient account 166 via the network. Thus, user 120 may use a web browser to access the accounts 144, 166 over the Internet.

The user device, in various embodiments, may include other applications to provide additional features available to user 120. In one example, these other applications may include security applications for implementing user-side security features, programmatic client applications for interfacing with appropriate application programming interfaces (APIs) over the network, and/or various other types of generally known programs and/or software applications. In still other examples, these other applications may interface with the network interface application for improved efficiency and convenience.

The user device, in one embodiment, may include at least one user identifier, which may be implemented, e.g., as operating system registry entries, cookies associated with the network interface application, identifiers associated with hardware of the user device, and/or various other appropriate identifiers. The user identifier may include one or more attributes and/or parameters associated with the user, such as personal information related to the user (e.g., one or more user names, passwords, photograph images, biometric ids, addresses, phone numbers, etc.) and banking information (e.g., one or more banking institutions, credit card issuers, user account numbers, security data and information, etc.). In various aspects, the user identifier may be passed with a login request and/or fund transfer request to financial institution 140 and/or payment provider 160 via the network, and the user identifier may be used by financial institution 140 and/or payment provider 160 to associate user 120 with accounts maintained with the respective systems.

In one embodiment, as with user 120, recipient 130 may utilize a network interface device, such as a PC, a wireless telephone, a PDA, a notebook computer, and/or various other generally known types of wired and/or wireless computing devices, to communicate and interface with payment provider 160 to access recipient account 166 via any appropriate combination of hardware and/or software configured for wired and/or wireless communication over the network. For instance, recipient 130 may utilize a network interface application to communicate and interface with payment provider 160 to access recipient account 166 via the network. As such, in this instance, recipient 130 may use a web browser to access recipient account 166 over the Internet. Even though not shown, it should be appreciated that recipient 130 may have a recipient account with financial institution 140 or a different financial institution, without departing from the scope of the present disclosure. As such, recipient 130 would also be able to access the recipient's account maintained by an institution other than payment provider 160 the network.

In one embodiment, financial institution 140 and/or payment provider 160 may maintain one or more servers on the network for processing financial transactions including fund transfers over the network. Each of the one or more servers for financial institution 140 and/or payment provider 160 may include one or more databases for storing information related to bill payment service 142, user account 144, recipient account 166, and bill payment network 150. Each of the one or more servers for financial institution 140 and/or payment provider 160 may include some form of network interface application configured to provide access to bill payment service 142, user account 144, recipient account 166, and bill payment network 150 over the network to user 120 and recipient 130. For example, user 120 may interact with the network interface application through a browser application over the network to access user account 144.

Payment provider 160, in one embodiment, is adapted to process financial transitions including fund transfers over the network on behalf of user 120 and/or recipient 130. As discussed above, only a recipient account is required for fund transfers. Payment provider 160 may utilize some form of fund transfer and settlement application configured to interact with user 120 and/or recipient 130 to facilitate fund transfers. In one example, the service provider 160 may be PayPal, Inc. of San Jose, Calif.

Payment provider 160, in one embodiment, may be configured to maintain a plurality of accounts (e.g., at least for a recipient, but possibly also for a payer), each of which may include account information associated with user 120 and/or recipient 130. For example, account information may include private financial information of user 120 and/or recipient 130, such as one or more account numbers, passwords, credit card information, banking information, or other types of financial information, which may be used to facilitate financial transactions including fund transfers over the network. In various implementations, system 100 described herein may be modified to accommodate users and/or recipients that may or may not be associated with at least one existing account, without departing from the scope of the present disclosure. In such cases, payment provider 160 may prompt for a sign-up of an account if needed.

In one embodiment, user 120 and/or recipient 130 may have identity attributes stored with financial institution 140 and/or payment provider 160, and user 120 and/or recipient 130 may have credentials to authenticate or verify identity with financial institution 140 and/or payment provider 160. In one aspect, user attributes may include personal information and/or banking information, as previously described. In various aspects, the user attributes may be passed to financial institution 140 and/or payment provider 160 as part of a login, account access request, fund transfer request, and/or payment request, and the user attributes may be utilized by financial institution 140 and/or service provider 160 to associate user 120 and/or recipient 130 with accounts, which are maintained by financial institution 140 and/or payment provider 160.

In one embodiment, financial institution 140 and/or payment provider 160 may be associated with at least one identifier, which may be included as part of a financial transaction including a fund transfer. The identifier may include one or more attributes and/or parameters related to financial institution 140 and/or payment provider 160, such as business and/or banking information. In one example, the identifier for financial institution 140 may be passed to payment provider 160 when user 120 requests a fund transfer from financial institution 140 to payment provider 160. In this instance, the identifier may be used by payment provider 160 to identify and/or verify user account 144 in reference to financial institution 140.

In one embodiment, processing component 162 of payment provider 160 may utilize a processing module to process fund transfers between user account 144 and recipient account 166 through bill payment network 150. In one implementation, the processing module is adapted to assist with resolving financial transactions including fund transfers through validation, delivery, and settlement. For example, processing component 162 in conjunction with the processing module may be adapted to resolve fund transfers between the various parties, where the accounts may be directly and/or automatically debited and/or credited of monetary funds in a manner as accepted by the banking industry.

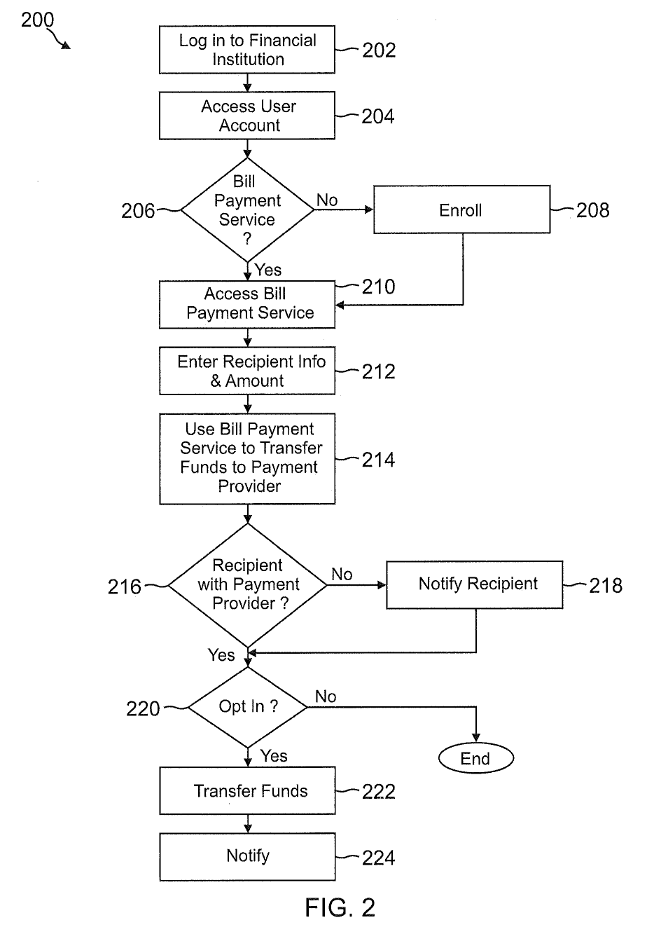

FIG. 2 shows one embodiment of a flowchart 200 for facilitating an on-line payment. At step 202, the user logs into the user's financial institution, such as a bank or credit union website. The user can access the website through a user device, such as a phone or laptop with an associated virtual keyboard, keypad, or keyboard, using a web browser application. If the login information is correct, the user is provided access to the user's account at step 204. Next, the user accesses the bill payment service, such as Bill Pay. If the user has not signed up for the bill payment service, as determined at step 206, the user is prompted to enroll in the service and enrolls at step 208 to gain access privileges of the bill payment service. Once the user is enrolled in the bill payment service, the user is given access to the bill payment service at step 210.

Next, at step 212, the user enters identifying information about the recipient of the funds and an amount. In one embodiment, the identifying information is the recipient's email address. Other information may include the recipient's name, phone number, or mailing address. The bill payment service, through its network, then transfers the requested amount to a payment provider, such as PayPal, at step 214, along with information about the recipient. The payment provider, at step 216, determines whether the recipient has an account with the payment provider, such as by searching the recipient information (e.g., email address) against an account database of the payment provider. If the intended recipient does not have an account with the payment provider, the payment provider sends a notification to the recipient at step 218. Notification can be through the information provided by the user at step 212. For example, if the information is an email address, the payment provider may send an email; if the information is a phone number, the payment provider may call the recipient and give a vocal (pre-recorded or live) message or leave a message; and if the information is a mailing address, the payment provider may mail a notice. The information in the notice, in whatever form, may include a request to sign up for an account with the payment provider, a notice that someone wants to transfer money to the recipient, identify of the payer, amount of the transfer, etc.

Once the recipient has an account with the payment provider, the payment provider may ask the recipient, at step 220, whether to opt in or agree to money transfers to the recipient's account. This may be a one-time request, periodic, or each time a money transfer is requested by a user. If the recipient does not want to use this service, the transfer process is ended, and the funds are re-deposited back to the user's or payer's account with the financial institution through the bill payment service and network. The user can also be notified that the transfer request was not successful, with or without reasons for the failed transfer. However, if as determined at step 220, the recipient accepts the service of money transfer, the payment provider transfers the requested amount, at step 222, into the recipient's account with the payment provider. Next, at step 224, the payment provider may notify the user and/or recipient of the successful transfer. The recipient may then withdraw funds, transfer funds to a different account (such as a bank account), or use the funds to purchase goods on-line through the payment provider.

As a result, money can be transferred from a bank account to a recipient through a bill payment service even when the recipient is not part of the bill payment network, which may be the case for individuals and small/mid-sized companies. Furthermore, the payer can easily make such a payment or transfer, by simply entering in easy-to-remember information about the recipient, such as an email address, and a transfer amount. Consequently, the user can make payments without the hassles, costs, and inconvenience of writing and sending a paper check, while still entering in basically the same or less information as in writing a check, namely the recipient and amount. Funds may also be available much faster than with paper checks.

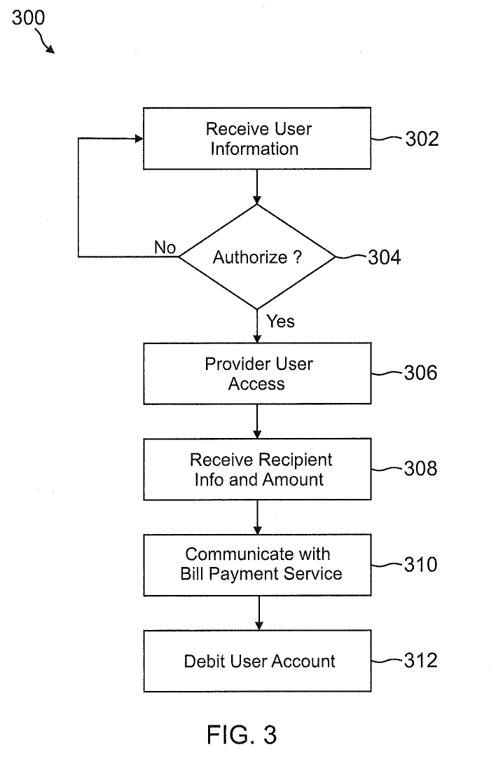

FIG. 3 shows a flowchart 300 for facilitating a financial institution-side on-line payment over a network according to one embodiment. At step 302, the financial institution receives information from a user or payer attempting to access the financial institution's webpage. Information includes data needed for the user to log in and access the user account and may include a user name, a password, an email address, and/or an account number. The information may be entered from the financial institution's webpage accessed through the user's device, such as a phone, laptop, or desktop with associated keypads or virtual keyboards. At step 304, the financial institution determines whether the received information matches with a valid account. If not, the user is prompted to enter information again. If the requested information is correct, the financial institution provides the user access to the user's account at step 306.

Once within the account, the user enters information about the recipient and the amount of funds to be transferred, which is received by the financial institution at step 308. In one embodiment, the recipient information is an email address. The recipient information and transfer or payment amount is then communicated with a bill payment service at step 310. The bill payment service processes this information with a payment provider, as discussed in detail throughout, to affect a transfer of funds to the recipient's account with the payment provider. If the transfer is successful, the financial institution debits the same amount from the user's account with the financial institution at step 312.

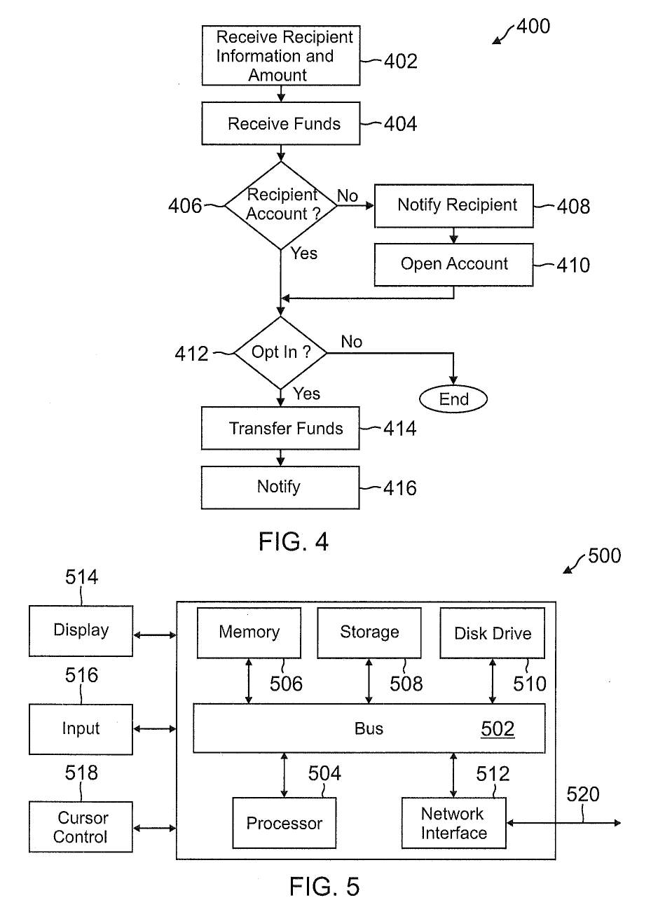

FIG. 4 shows a flowchart 400 illustrating a payment provider-side method for facilitating a money transfer over a network according to one embodiment. After the user has logged into the financial institution website, accessed the user account and the bill payment service, and entered recipient information and payment amount, the payment provider receives the recipient information and payment amount at step 402. The payment provider receives the requested amount through the bill payment service at step 404. Note that step 404 may be performed before step 402 or at the same time. Next, at step 406, the payment provider determines, from the information received at step 402, whether the recipient has an existing account with the payment provider. In one embodiment, the payment provider searches an account database to determine if an account exists associated with the recipient, such as by matching emails. If no valid account exists, the payment provider notifies the recipient at step 408, such as through an email message, a phone call, or a letter. The method of notification depends in part on the type of information received from the user at step 402. The recipient may decide to then open an account or update a closed account with the payment provider, such as by entering the recipient's name, user name, password, credit card information, bank information, mailing address, phone number, or anything requested by the payment provider. Upon receiving and verifying the information as needed, the payment provider opens a new or pre-existing account for the recipient at step 410.

Once the payment provider determines the recipient has a valid account, the payment provider asks the recipient, at step 412, whether the recipient wishes to use this form of money transfer. In particular, the payment provider can notify the recipient that the payment provider provides a service in which the recipient can receive funds directly into the recipient's account when a transfer is initiated by a payer through a financial institution, with the payer only needing to know the recipient's email address or other identifying information. If the intended recipient does not want to authorize or use this service, the payment provider ends the transaction and the funds are returned to the payer's financial institution account.

However, if the recipient agrees to use the service, the payment provider transfers the requested amount into the recipient's account with the payment provider at step 414. Note that the request for opt-in or authorization can be a one-time request, at regular intervals, or each time a request from a payer is made. Authorization can also be requested when the payment provider determines a particular payment request is not of the norm, e.g., risk of fraud. Once the transfer is completed, the payment provider may notify, at step 416, the recipient and/or the payer.

FIG. 5 is a block diagram of a computer system 500 suitable for implementing one or more embodiments of the present disclosure. In various implementations, the user device may comprise a personal computing device (e.g., a personal computer, laptop, cell phone, PDA, etc.) capable of communicating with the network, financial institution 140 may utilize a network computing device (e.g., a network server) capable of communicating with the network, and payment provider 160 may utilize a network computing device (e.g., a network server) capable of communicating with the network. It should be appreciated that each of the devices utilized by user 120, financial institution 140, and payment provider 160 may be implemented as computer system 400 in a manner as follows.

In accordance with various embodiments of the present disclosure, computer system 500, such as a personal computer and/or a network server, includes a bus 502 or other communication mechanism for communicating information, which interconnects subsystems and components, such as a processing component 504 (e.g., processor, micro-controller, digital signal processor (DSP), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 516 (e.g., keyboard, keypad, or virtual keyboard), and a cursor control component 518 (e.g., mouse, pointer, or trackball). In one implementation, disk drive component 510 may comprise a database having one or more disk drive components.

In accordance with embodiments of the present disclosure, computer system 500 performs specific operations by processor 504 executing one or more sequences of one or more instructions contained in system memory component 506. Such instructions may be read into system memory component 506 from another computer readable medium, such as static storage component 508 or disk drive component 510. In other embodiments, hardwired circuitry may be used in place of or in combination with software instructions to implement the present disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, non-volatile media includes optical or magnetic disks, such as disk drive component 510, volatile media includes dynamic memory, such as system memory component 506, and transmission media includes coaxial cables, copper wire, and fiber optics, including wires that comprise bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by a communication link 520 to the network (e.g., such as a LAN, WLAN, PTSN, and/or various other wired or wireless networks, including telecommunications, mobile, and cellular phone networks) may perform instruction sequences to practice the present disclosure in coordination with one another.

Computer system 500 may transmit and receive messages, data, information and instructions, including one or more programs (i.e., application code) through communication link 520 and a communication interface 512. Received program code may be executed by processor 504 as received and/or stored in disk drive component 510 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method for facilitating financial transactions over a network, the method comprising:
receiving an email address of a recipient and a payment amount;
receiving funds in the payment amount from a bill payment service; and
transferring the funds to a recipient account with a payment provider.

2. The method of claim 1, further comprising determining whether the recipient has an account with the payment provider.

3. The method of claim 2, wherein the determining comprises using the email address to search for accounts with the payment provider.

4. The method of claim 1, further comprising obtaining approval from the recipient prior to the transferring.

5. The method of claim 4, wherein the approval is obtained prior to each individual transfer.

6. The method of claim 4, wherein the approval is obtained only once.

7. The method of claim 1, further comprising notifying the recipient of an intended transfer of the payment amount.

8. The method of claim 7, wherein the notifying comprises providing an identity of a payer of the funds.

9. The method of claim 1, wherein the email address and the payment amount are entered by a payer from a financial institution website.

10. The method of claim 1, wherein the recipient is not part of the bill payment service.

11. The method of claim 1, wherein the recipient is not an entity authorized to receive payments directly through the bill payment service.

12. The method of claim 1, further comprising notifying the recipient and/or a payer when the funds are transferred.

13. A method for making payments over a network, comprising:
receiving a payer's information to access an account with a financial institution;
granting access to a payer's account with the financial institution;
receiving a recipient's email address and an amount to be transferred from the payer's account;
communicating the recipient's email address and the amount with a bill payment service; and
debiting the amount from the payer's account.

14. The method of claim 13, wherein the recipient is not an authorized receiver of funds of the bill payment service.

15. The method of claim 13, wherein the financial institution is part of the bill payment service.

16. The method of claim 13, wherein the payer is part of the bill payment service.

17. Software encoded in a computer readable medium and when executed operable to facilitate financial transactions over a network, the software further operable to:
receive an email address of a recipient and a payment amount;
receive funds in the payment amount from a bill payment service; and
transfer the funds to a recipient account with a payment provider.

18. The software of claim 17, further operable to determine whether the recipient has an account with the payment provider.

19. The software of claim 17, further operable to obtain approval from the recipient prior to the transferring.

20. The software of claim 17, further operable to notify the recipient of an intended transfer of the payment amount.

21. The software of claim 17, wherein the email address and the payment amount are entered by a payer from a financial institution website.

22. The software of claim 17, wherein the recipient is not part of the bill payment service.

23. The software of claim 17, further operable to notify the recipient and/or a payer when the funds are transferred.
